(19) United States
(12) Patent Application Publication
(10) Pub. No.: US 2019/0239305 A1
(43) Pub. Date: Aug. 1, 2019

(54) ELECTRIC DEVICE AND AUTOMOTIVE LIGHTING DEVICE

(71) Applicant: VALEO ILUMINACION, Martos (ES)

(72) Inventors: Juan LARA-CABEZA, Martos (ES); Juan-Jose Santaella, Martos (ES); Antonio Domingo Illan, Martos (ES); Miguel-Angel Pena, Martos (ES)

(73) Assignee: VALEO ILUMINACION, Martos (ES)

(21) Appl. No.: 16/260,418

(22) Filed: Jan. 29, 2019

(30) Foreign Application Priority Data
Jan. 30, 2018 (EP) 18382056.2

(51) Int. Cl. H05B 33/08

(52) U.S. Cl. CPC H05B 33/0845; H05B 33/0827

(57) ABSTRACT

An electric device including light sources and a light driver including at least a control output, the light driver being configured to selectively activate or deactivate current flow in each control output. The electric device also includes at least one current sink device, each current sink device being arranged between one of the light sources and one of the control outputs. Each current sink device includes a first input, a second input, a first output and a second output, the first and second inputs being connected to the light source and the first output being connected to the corresponding control output. A first current portion passes through the first input and the first output, and a second current portion passes through the second input.

### TECHNICAL FIELD

This invention is related to the field of automotive lighting devices.

### STATE OF THE ART

Current automotive lighting devices require increasing control abilities. Complex animations and other functionalities means that a great number of LED light sources need individual control, and global management of these light sources is also required.

This is becoming a trend, due to matrix arrangements and other similar developments.

Microcontrollers are used to perform these tasks. However, current drivers cannot achieve current regulation with a high tolerance. The necessity to join multiple outputs to achieve high current for all the branches limits the use of these devices. When the number of branches increases, the driver does not have enough output, so it is not possible to join outputs to increase the current. Current developments use more drivers, but this is more expensive.

### DESCRIPTION OF THE INVENTION

The invention provides a solution for this problem by means of a method for manufacturing an automotive prototype part according to claim 1. Preferred embodiments of the invention are defined in dependent claims.

In an inventive aspect, the invention provides an electric device for an automotive lighting device, the electric device comprising
a plurality of light sources configured to be electrically fed by a power source, each light source requiring a first predetermined current value to emit light;
a light driver comprising an input configured to be electrically fed by the power source and at least a control output, the control output allowing a maximum output current value lower than the first predetermined current value, the light driver being configured to selectively activate or deactivate current flow in each control output;
at least one current sink device, each current sink device being arranged between one of the light sources and one of the control outputs;

wherein
the light source is configured so that a first current passes through it, the first current being at least the first predetermined current value,
the current sink device comprises a first input, a second input, a first output and a second output, the first and second inputs being connected to the light source and the first output being connected to the corresponding control output;
the first input and the first output are arranged so that a first current portion passes through them when the electric device is in operation, this first current portion being lower or equal to the maximum output current value
the second input is arranged so that a second current portion passes through it when the electric device is in operation, this second current portion being equal or greater than the difference between the first predetermined current value and the maximum output current value.

The control outputs of the led driver act as electric “inputs”, since the current comes from the power source, goes though the light source, then to the current sink device and then arrives to the control output. However, since these ports are usually called “control outputs”, this term is being used through the application.

This electric device is suitable for controlling at least one light source which requires a current value which is greater than the maximum current value accepted by the light driver output, without the need of connecting two light driver outputs in parallel to said light source. This is a great advantage, since the increasing number of light sources to be controlled and the predetermined current value, which is usually greater than the maximum current value accepted by the light driver outputs usually makes it necessary to have several light drivers, thus increasing cost and complexity.

In some particular embodiments, the electric device comprises more than one current sink device, each current sink device being arranged between one light source and the corresponding control output.

Current automotive lighting devices comprise a great number of light sources to be controlled, so this electric device makes it possible to control them by using a single light driver.

In some particular embodiments, the second output of the current sink device is connected to ground.

This connection to ground helps the current sink device to have a more stable behaviour.

In some particular embodiments, the current sink device comprises a first resistor with an input and an output and a second resistor with an input and an output, and the second current portion is N times the first current portion, N being the ratio between the first resistor and the second resistor.

This is one of the multiple ways of achieving this solution. The embodiments comprising this feature are simple and use cheap elements.

In further particular embodiments, the current sink device comprises a first transistor and a second transistor,
the first transistor having an emitter connected to the first input of the current sink device, a base connected to the collector and a collector connected to the input of the first resistor,
the input of the second resistor being connected to the second input of the current sink device
the second transistor having an emitter connected to the output of the second resistor, a base connected to the output of the first resistor and a collector connected to the second output of the current sink device.

This is one of the multiple ways of achieving this solution. These embodiments provide a simple arrangement with cheap elements.

In a further inventive aspect, the invention provides an automotive lighting device comprising a power source and an electric device according to the previous inventive aspect being fed by the power source.

This automotive lighting device is able to control the operation of several light sources without using more than one led driver, thus saving cost.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows an electric device according to the invention, which is suitable for being used in an automotive lighting device.

FIG. 2 shows a particular example of a current sink device used in an electric device according to the invention.

FIG. 3 shows an automotive lighting device comprising an electric device according to the invention.

### DETAILED DESCRIPTION OF THE INVENTION

FIG. 1 shows an electric device 10 which is suitable for being used in an automotive lighting device. This electric device 10 comprises
a plurality of light sources 1;
a light driver 3, which is intended to control the operation of the light sources 1 by means of control outputs 32
a plurality of current sink devices 4 arranged between each light source 1 and its corresponding control output 32.

Each light source 1 requires a first predetermined current value to emit light, as a nominal value. As a consequence, the light sources 1 are fed by a power source 2, which provides a voltage so that a first current IT passes through each light source 1.

The light driver 3 comprises an input 31 configured to be electrically fed by the power source 2 and one control output 32 for each light source. This light driver 3 is configured to selectively activate or deactivate current flow in each control output 32, so that each light source 1 may be turned on or turned off in a controlled way.

However, each control output 32 only allows a maximum output current value, which is lower than the first predetermined current value. this maximum output current value is limited because the light driver 3 is a sensitive element, and cannot bear a high total current. Further, for thermal reasons, the current in each control output 32 is limited. As a consequence, if each light source 1 was directly connected to a control output 32, the light sources 1 could not work properly, since the required first predetermined current value could not pass through them, because the control outputs would receive a current which is higher than their maximum output current value.

As a consequence, a plurality of current sink devices 4 are comprised in this electric device 10, each current sink device 4 being arranged between one of the light sources 1 and one of the control outputs 32.

Each current sink device comprises a first input 41, a second input 42, a first output 43 and a second output 44, the first 41 and second 42 inputs being connected to the light source 1 and the first output 43 being connected to the corresponding control output 32. In the particular embodiment shown in this figure, the second output 44 of the current sink device is connected to ground.

When the electric device 10 is in operation, a first current IT passes through each light source 1, this first current IT being at least the first predetermined current value.

However, not all this first current IT arrives at the corresponding control output 32, since it would cause the malfunction of the light driver 3, but only a first current portion I1, which pass through the first input 41 of the current sink device 4 and exits by the first output 43 of the current sink device 4, arrives at the corresponding control output 32. This first current portion I1 is equal or lower than the maximum output current value, so that the light driver 3 may work normally.

On the other hand, a second current portion I2 passes through the second input 42 when the circuit is in operation. This second current portion I2 is the difference between the first current IT and the first current portion I1, and is therefore equal or greater than the difference between the first predetermined current value and the maximum output current value.

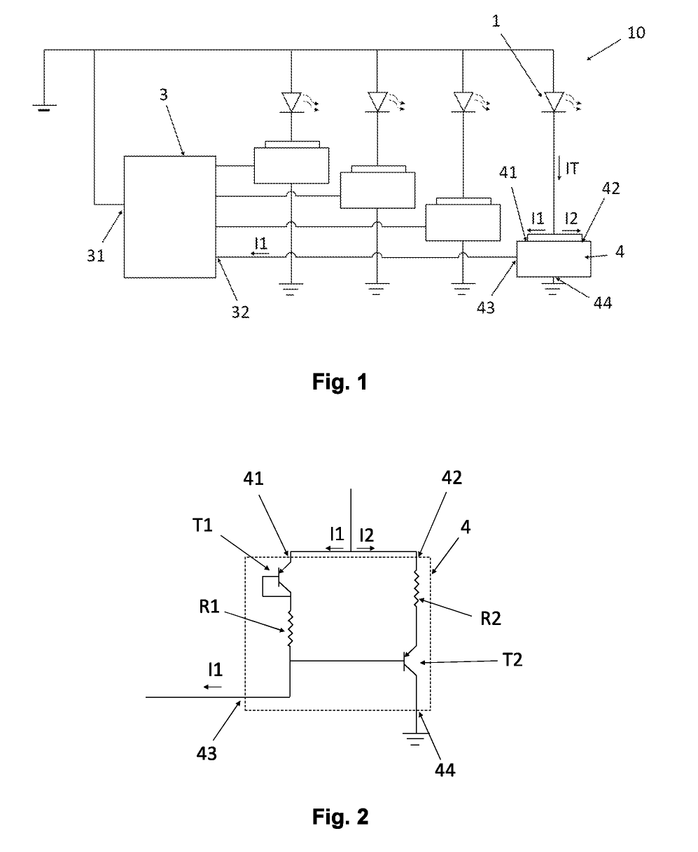

FIG. 2 shows a particular example of a current sink device 4 which is used in an electric device 10 according to the invention.

This current sink device 4 comprises
a first resistor R1 with an input and an output;
a second resistor R2 with an input and an output;
a first transistor T1; and
a second transistor T2.

The first transistor T1 has an emitter connected to the first input 41 of the current sink device 4, a base connected to the collector and a collector connected to the input of the first resistor R1, and the input of the second resistor R2 is in turn connected to the second input 42 of the current sink device 4. On the other hand, the second transistor T2 has an emitter connected to the output of the second resistor R2, a base connected to the output of the first resistor R1 and a collector connected to the second output 44 of the current sink device 4.

As a consequence, the second current portion I2 is N times the first current portion I1, N being the ratio between the resistance of the first resistor R1 and the resistance of the second resistor R2.

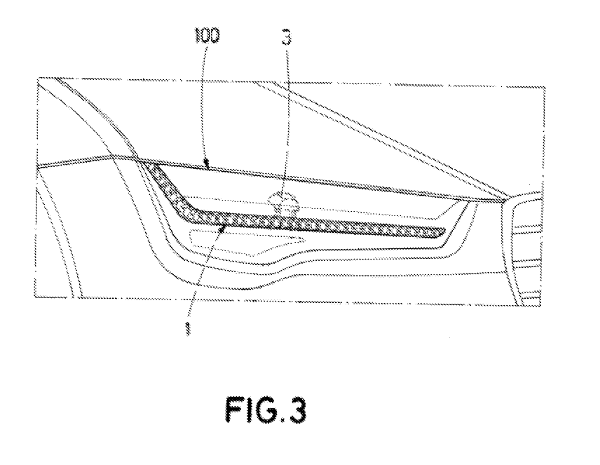

FIG. 3 shows an automotive lighting device 100 comprising a power source and an electric device 10 according to any of the preceding claims fed by the power source.

1. Electric device for an automotive lighting device, the electric device comprising
a plurality of light sources configured to be electrically fed by a power source, each light source requiring a first predetermined current value to emit light;
a light driver comprising an input configured to be electrically fed by the power source and at least a control output, the control output allowing a maximum output current value lower than the first predetermined current value, the light driver being configured to selectively activate or deactivate current flow in each control output;
at least one current sink device, each current sink device being arranged between one of the light sources and one of the control outputs;
wherein
the light source is configured so that a first current passes through it, the first current being at least the first predetermined current value,
the current sink device comprises a first input, a second input,
a first output and a second output, the first and second inputs being connected to the light source and the first output being connected to the corresponding control output;
the first input and the first output are arranged so that a first current portion passes through them when the circuit is in operation, this first current portion being lower or equal to the maximum output current value;
the second input is arranged so that a second current portion passes through it when the circuit is in operation, this second current portion being equal or greater than the difference between the first predetermined current value and the maximum output current value.

2. Electric device according to claim 1, comprising more than one current sink device, each current sink device being arranged between one light source and the corresponding control output.

3. Electric device according to claim 1, wherein the second output of the current sink device is connected to ground.

4. Electric device according to claim 1, wherein the current sink device comprises a first resistor with an input and an output and a second resistor with an input and an output, and the second current portion RPM is N times the first current portion, N being the ratio between the first resistor and the second resistor.

5. Electric device according to claim 4, wherein the current sink device comprises a first transistor and a second transistor,
the first transistor having an emitter connected to the first input of the current sink device, a base connected to the collector and a collector connected to the input of the first resistor,
the input of the second resistor being connected to the second input of the current sink device,
the second transistor having an emitter connected to the output of the second resistor, a base connected to the output of the first resistor and a collector connected to the second output of the current sink device.

6. Automotive lighting device comprising a power source and an electric device according to claim 1 fed by the power source.

7. Electric device according to claim 2, wherein the second output of the current sink device is connected to ground.

8. Electric device according to claim 2, wherein the current sink device comprises a first resistor with an input and an output and a second resistor with an input and an output, and the second current portion is N times the first current portion, N being the ratio between the first resistor and the second resistor.

9. Electric device according to claim 3, wherein the current sink device comprises a first resistor with an input and an output and a second resistor with an input and an output, and the second current portion is N times the first current portion, N being the ratio between the first resistor and the second resistor.

10. Automotive lighting device comprising a power source and an electric device according to claim 2 fed by the power source.

11. Automotive lighting device comprising a power source and an electric device according to claim 3 fed by the power source.

12. Automotive lighting device comprising a power source and an electric device according to claim 4 fed by the power source.

13. Automotive lighting device comprising a power source and an electric device according to claim 5 fed by the power source.
